(19) United States
(12) Patent Application Publication
(10) Pub. No.: US 2026/0050832 A1
(43) Pub. Date: Feb. 19, 2026

(54) INFORMATION PROCESSING SYSTEM, INFORMATION PROCESSING DEVICE, AND INFORMATION PROCESSING METHOD

(71) Applicant: NEC Corporation, Tokyo (JP)

(72) Inventor: Junki MORI, Tokyo (JP)

(73) Assignee: NEC Corporation, Tokyo (JP)

(21) Appl. No.: 19/283,764

(22) Filed: Jul. 29, 2025

(30) Foreign Application Priority Data
Aug. 15, 2024 (JP) 2024-135608

(51) Int. Cl. G06N 20/00

(52) U.S. Cl. CPC G06N 20/00

(57) ABSTRACT

A first information processing device includes a first acquisition unit acquiring a first feature representing a subject and a result, a first prediction unit predicting an intervention situation that could have affected the result based on the first feature, and a first prediction model training unit training a prediction model that predicts an effect of intervention by federated learning based on a third feature converted from the first feature, the result, and the intervention situation. A second information processing device includes a second acquisition unit acquiring a second feature representing a subject and an intervention situation, a second prediction unit predicting a result based on the second feature, and a second prediction model training unit training a prediction model by federated learning based on the third feature converted from the second feature, the result, and the intervention situation.

This application is based upon and claims the benefit of priority from Japanese Patent Application No. 2024-135608, filed on Aug. 15, 2024, the disclosure of which is incorporated herein in its entirety by reference.

### TECHNICAL FIELD

The present disclosure relates to an information processing system, an information processing device, and an information processing method.

### BACKGROUND ART

Techniques are known for predicting the effect of an intervention to be performed to affect the outcome for a subject. For example, WO 2021/235200 A1 describes a technique for predicting an increase in a product purchase rate (an example of an effect of intervention) due to intervention of product advertisement display based on a feature of a user (an example of a subject). According to the technology, the prediction model that predicts the effect of the advertisement display based on the feature of the user is generated using the training data in which the feature of the user, the presence or absence of the advertisement display, and the presence or absence of the product purchase are associated with each other.

### SUMMARY

Here, the organization that knows the intervention situation with respect to the subject (for example, an advertisement distributor who knows the presence or absence of advertisement display for a user) and the organization that knows the results obtained for the subject (for example, an advertiser that knows whether a user has purchased a product) may be different. It may be difficult to exchange information between such different organizations so as to be able to associate the intervention situation and the result. Also, between such different organizations, at least a part of the features obtainable for the subject may be different. For example, an organization that knows the intervention situation can acquire the email address of the user but cannot acquire the gender, and an organization that knows the result cannot acquire the email address of the user but can acquire the gender. In the technique described in WO 2021/235200 A1, there is a problem that the effect of the intervention cannot be predicted in a case where the intervention situation related to the subject and the organization capable of acquiring the result obtained for the subject are different from each other, and at least a part of the features indicating the subject that can be acquired between the organizations are different from each other.

The present disclosure has been made in view of the above problems, and an exemplary object of the present disclosure is to provide a technique capable of predicting an effect of an intervention from each feature in a case where an intervention situation related to a subject and a result obtained for the subject cannot be acquired in association with each other, and at least a part of features that can be acquired together with the intervention situation and the result with respect to the subject are different.

An information processing system according to an exemplary aspect of the present disclosure includes: a first information processing device; and a second information processing device, where the first information processing device includes: one or more memories storing instructions; and one or more processors configured to execute the instructions to: acquire a first feature representing a subject and a result obtained for the subject; predict an intervention situation that could have affected the result based on the first feature; and train a prediction model that predicts an effect of the intervention using federated learning performed by the first information processing device and the second information processing device based on a third feature converted from the first feature, the result, and the intervention situation, the second information processing device includes: one or more memories storing instructions; and one or more processors configured to execute the instructions to: acquire a second feature representing a subject and the intervention situation; predict the result based on the second feature; and train the prediction model by the federated learning based on the third feature converted from the second feature, the result, and the intervention situation, and the third feature is a feature converted from the first feature and the second feature in such a way that feature distributions are similar in a same feature space.

An information processing device according to an exemplary aspect of the present disclosure includes: one or more memories storing instructions; and one or more processors configured to execute the instructions to: acquire a feature representing a subject and a result obtained for the subject; predict an intervention situation that could have affected the result based on the feature; and train a prediction model that predicts an effect of the intervention using federated learning performed by another information processing device capable of acquiring the intervention situation and the information processing device based on a converted feature converted from the feature, the result, and the intervention situation, wherein the converted feature is a feature converted from the feature and another feature acquired for the subject by the another information processing device in such a way that feature distributions are similar in a same feature space.

An information processing device according to an exemplary aspect of the present disclosure includes: one or more memories storing instructions; and one or more processors configured to execute the instructions to: acquire a feature representing a subject and an intervention situation that could have affected a result obtained for the subject; predict the result based on the feature; and train a prediction model that predicts an effect of the intervention using federated learning performed by another information processing device capable of acquiring the result and the information processing device based on a converted feature converted from the feature, the result, and the intervention situation, wherein the converted feature is a feature converted from the feature and another feature acquired for the subject by the another information processing device in such a way that feature distributions are similar in a same feature space. An information processing method according to an exemplary aspect of the present disclosure is executed by an information processing system including a first information processing device and a second information processing device, the method including: acquiring, by at least one processor included in the first information processing device, a first feature representing a subject and a result obtained for the subject; predicting, by at least one processor included in the first information processing device, an intervention situation that could have affected the result based on the first feature; training, by at least one processor included in the first information processing device, a prediction model that predicts an effect of the intervention using federated learning performed by the first information processing device and the second information processing device based on a third feature converted from the first feature, the result, and the intervention situation; acquiring, by at least one processor included in the second information processing device, a second feature representing a subject and the intervention situation; predicting, by at least one processor included in the second information processing device, the result based on the second feature; and training, by at least one processor included in the second information processing device, the prediction model by the federated learning based on the third feature converted from the second feature, the result, and the intervention situation, wherein the third feature is a feature converted from the first feature and the second feature in such a way that feature distributions are similar in a same feature space.

An information processing method executed by a computer including: acquiring, by at least one processor included in an information processing device, a feature representing a subject and a result obtained for the subject; predicting, by the at least one processor, an intervention situation that could have affected the result based on the feature; and training, by the at least one processor, a prediction model that predicts an effect of the intervention using federated learning performed by another information processing device capable of acquiring the intervention situation and the information processing device based on a converted feature converted from the feature, the result, and the intervention situation, wherein the converted feature is a feature converted from the feature and another feature acquired for the subject by the another information processing device in such a way that feature distributions are similar in a same feature space.

An information processing method executed by a computer including: acquiring, by at least one processor included in an information processing device, a feature representing a subject and an intervention situation that could have affected a result obtained for the subject; predicting, by the at least one processor, the result based on the feature; and training, by the at least one processor, a prediction model that predicts an effect of the intervention using federated learning performed by another information processing device capable of acquiring the result and the information processing device based on a converted feature converted from the feature, the result, and the intervention situation, wherein the converted feature is a feature converted from the feature and another feature acquired for the subject by the another information processing device in such a way that feature distributions are similar in a same feature space. According to an exemplary aspect of the present disclosure, there is an exemplary effect that it is possible to provide a technology capable of predicting an effect of an intervention from each feature in a case where an intervention situation related to a subject and a result obtained for the subject cannot be acquired in association with each other, and a feature that can be acquired together with the intervention situation related to the subject and a feature that can be acquired together with the result are different for the subject.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an information processing system according to the present disclosure;

FIG. 2 is a flowchart illustrating a flow of an information processing method according to the present disclosure;

FIG. 3 is a block diagram illustrating a configuration of an information processing device according to the present disclosure;

FIG. 4 is a flowchart illustrating a flow of an information processing method according to the present disclosure;

FIG. 5 is a block diagram illustrating a configuration of an information processing device according to the present disclosure;

FIG. 6 is a flowchart illustrating a flow of an information processing method according to the present disclosure;

FIG. 7 is a diagram schematically illustrating an outline of an information processing system according to the present disclosure;

FIG. 8 is a diagram schematically illustrating an outline of each model according to the present disclosure;

FIG. 9 is a block diagram illustrating a configuration of an information processing system according to the present disclosure;

FIG. 10 is a flowchart illustrating a flow of an information processing method according to the present disclosure;

FIG. 11 is a flowchart illustrating a flow of an information processing method according to a modification of the present disclosure;

FIG. 12 is a diagram schematically illustrating an application example using the information processing system according to the present disclosure; and

FIG. 13 is a block diagram illustrating a hardware configuration of a computer that functions as each device according to the present disclosure.

### EXAMPLE EMBODIMENT

Hereinafter, example embodiments of the present disclosure will be described. However, the present disclosure is not limited to the example embodiments to be described below, and various modifications can be made within the scope described in the claims. For example, example embodiments obtained by appropriately combining techniques (some or all of things or methods) adopted in the following example embodiments can also be included in the scope of the present disclosure. Example embodiments obtained by appropriately omitting some of the techniques adopted in the following example embodiments can also be included in the scope of the present disclosure. Advantages mentioned in the following example embodiments are examples of advantages expected in the example embodiments, and do not define extensions of the present disclosure. That is, example embodiments that do not achieve the advantages mentioned in the following example embodiments can also be included in the scope of the present disclosure.

### First Example Embodiment

A first example embodiment that is an example of an example embodiment of the present disclosure will be described in detail with reference to the drawings. The present example embodiment is a basic form of each example embodiment to be described below. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in the drawings referred to for describing the present example embodiment can also be employed in the other example embodiments included in the present disclosure within a range in which no particular technical problem occurs.

### (Outline of Information Processing System 1)

An information processing system 1 is a system that generates, by cooperation of a plurality of information processing devices, a prediction model that predicts an effect of intervention that can affect a result obtained for a subject based on a feature regarding the subject. Hereinafter, a method for generating a prediction model by cooperation of a plurality of information processing devices will be referred to as federated learning.

Here, the “subject” is a subject for which the effect of the intervention should be predicted, and examples thereof include, but are not limited to, a visitor of a website, a patient in a medical institution, and the like. The “feature representing the subject” is information representing the subject, and examples thereof include, but are not limited to, age, gender, preference, product purchase history, treatment history, previous disease, and the like. The “intervention” is a process or an action performed to affect a result obtained for a subject, and examples thereof include, but are not limited to, “display of an advertisement”, “treatment”, and the like. The “effect of the intervention” is a degree to which the result obtained for the subject is better influenced by the intervention, and examples thereof include, but are not limited to, an increase in purchase rate due to display of an advertisement, an effect on a disease state due to treatment, and the like.

In order to generate a prediction model for predicting the effect of an intervention, for example, (i) a feature regarding a subject, (ii) a result obtained for the subject, and (iii) an intervention situation that could have affected the result are necessary as training data. The “intervention situation” may be, for example, the presence or absence of intervention itself, the type of intervention when it is performed, the degree of intervention, or the like, but is not limited thereto. Hereinafter, the “result obtained for a subject” may be referred to as a “result for a subject” or simply as a “result”. The “intervention situation that could have affected the result” may be described as “the intervention situation related to the subject” or simply as “the intervention situation”.

Here, an information processing device capable of acquiring the “result” is different from an information processing device capable of acquiring the “intervention situation”, and at least a part of the features that can be acquired with respect to the subject by each of these information processing devices may be different. In such a case, the information processing system 1 can create the above-described prediction model without requiring mutual disclosure of the features and the results or the intervention situations acquired by the information processing devices.

### (Configuration of Information Processing System 1)

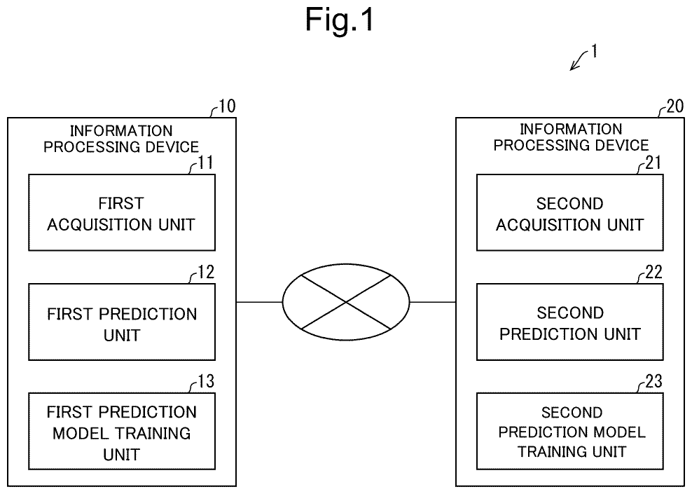

The configuration of the information processing system 1 will be described with reference to FIG. 1. FIG. 1 is a block diagram illustrating a configuration of the information processing system 1.

As illustrated in FIG. 1, the information processing system 1 includes an information processing device 10 and an information processing device 20. The information processing devices 10 and 20 are communicably connected via a network.

Each of the information processing devices 10 and 20 has at least a function of training a local model as a plurality of clients in federated learning. Any one of the information processing devices 10 and 20 may further have a function of integrating a plurality of local models as a server in the federated learning. Each of the information processing devices 10 and 20 may be communicably connected to a device (not illustrated) that functions as a server in the federated learning. The number of information processing devices 10 included in the information processing system 1 is not limited to one, and may be plural.

The number of information processing devices 20 included in the information processing system 1 is not limited to one, and may be plural.

The information processing device 10 is an example of a first information processing device. The information processing device 10 is a device capable of acquiring a first feature representing a subject and a result for the subject, but incapable of acquiring an intervention situation that could have affected the result. Details of the first feature will be described later.

The information processing device 10 includes a first acquisition unit 11, a first prediction unit 12, and a first prediction model training unit 13. The first acquisition unit 11 is an example of a configuration that implements a first acquisition means. The first prediction unit 12 is an example of a configuration that implements a first prediction means. The first prediction model training unit 13 is an example of a configuration that implements a first prediction model training means.

The first acquisition unit 11 acquires a first feature representing a subject and a result obtained for the subject.

Hereinafter, the information acquired by the first acquisition unit 11 is referred to as first input information. The first input information includes a feature representing a subject and a result obtained for the subject. The first input information desirably includes a set of the first feature and the result related to each of the plurality of subjects.

The first prediction unit 12 predicts the intervention situation that could have affected the result for the subject based on the first feature representing the subject. Specifically, the first prediction unit 12 predicts the intervention situation related to each of the plurality of subjects included in the first input information based on the first feature related to each of the plurality of subjects. For example, the first prediction unit 12 may perform prediction using a model that predicts an intervention situation related to the subject based on the first feature related to the subject.

The first prediction model training unit 13 trains the prediction model that predicts the effect of the intervention by the federated learning of the information processing devices 10 and 20 based on a third feature converted from the first feature, the result, and the intervention situation. For example, the first prediction model training unit 13 may train a first prediction model that predicts an effect of intervention based on a third feature converted from the first feature by machine learning with reference to a model in which the first prediction model and the second prediction model trained by the information processing device 20 are integrated, using the first input information and the predicted intervention situation as training data. The first prediction model and the second prediction model are local models in the federated learning. For example, the information processing device 10 may use the first prediction model after training as a prediction model, or may use a model in which the first prediction model and the second prediction model after training are integrated as a prediction model. Details of the third feature will be described later.

The information processing device 20 is an example of a second information processing device. The information processing device 20 is a device that can acquire a second feature representing the subject and the intervention situation that could have affected the result for the subject, but cannot acquire the result. Details of the second feature will be described later.

The information processing device 20 includes a second acquisition unit 21, a second prediction unit 22, and a second prediction model training unit 23. The second acquisition unit 21 is an example of a configuration that implements a second acquisition means. The second prediction unit 22 is an example of a configuration that implements a second prediction means. The second prediction model training unit 23 is an example of a configuration that implements a second prediction model training means.

The second acquisition unit 21 acquires the second feature representing the subject and the intervention situation that could have affected the result obtained for the subject. Hereinafter, the information acquired by the second acquisition unit 21 is referred to as second input information. The second input information includes the feature representing the subject and the intervention situation that could have affected the result obtained for the subject. The second input information desirably includes a set of the second feature and the intervention situation related to each of the plurality of subjects.

The second prediction unit 22 predicts a result for the subject based on the second feature representing the subject. Specifically, the second prediction unit 22 predicts a result for each of a plurality of subjects included in the second input information based on the second feature related to each of the subjects. For example, the second prediction unit 22 may perform prediction using a model that predicts a result for the subject based on the second feature regarding the subject.

The second prediction model training unit 23 trains the prediction model that predicts the effect of the intervention by the federated learning of the information processing devices 10 and 20 based on a third feature converted from the second feature, the result, and the intervention situation. For example, the second prediction model training unit 23 may train a second prediction model that predicts an effect of intervention based on a third feature converted from the second feature by machine learning with reference to a model in which the first prediction model and the second prediction model trained by the information processing device 10 are integrated, using the second input information and the predicted intervention situation as training data. As described above, the first prediction model and the second prediction model are local models in the federated learning. For example, the information processing device 20 may use the second prediction model after training as a prediction model, or may use a model in which the first prediction model and the second prediction model after training are integrated as a prediction model. Details of the third feature will be described later.

### (First Feature, Second Feature, and Third Feature)

The first feature that can be acquired by the information processing device 10 is at least partially different from the second feature that can be acquired by the information processing device 20. For example, in a case where the subject is a user, the first feature representing the subject may be “gender, age, marital status”, and the second feature may be “gender, age, deposit amount, loan amount”. As described above, the first feature includes the unique feature (in this example, marital status), and the second feature includes the unique feature (in this example, deposit amount, loan amount, and the like). The first feature and the second feature may include a common feature (in this example, gender, age). The first feature and the second feature may be different from each other without including the common feature.

The third feature is a feature converted from the first feature and the second feature such that feature distributions are similar in the same feature space. In other words, the third feature converted from the first feature and the third feature converted from the second feature have similar feature distributions. For example, the first feature may be converted into the third feature using a first conversion model. For example, the second feature may be converted into the third feature using a second conversion model. The first conversion model and the second conversion model may be generated in advance.

### (Federated Learning)

Here, as a technique by which the first prediction model training unit 13 and the second prediction model training unit 23 train a prediction model, for example, federated learning is adopted. In other words, each of the first prediction model and the second prediction model is trained by federated learning. The “integrated model” is called, for example, a global model in the federated learning. As described above, each of the first prediction model and the second prediction model is referred to as, for example, a local model in the federated learning. In other words, the first prediction model, the second prediction model, and the global model are trained as prediction models by the federated learning.

In the federated learning, (i) the information processing device 10 trains the first prediction model with reference to the global model, and the information processing device 20 trains the second prediction model with reference to the global model, and (ii) the first prediction model after training and the second prediction model after training are integrated to generate a new global model are repeated. The training data used for training of the first prediction model and the training data used for training of the second prediction model do not need to be disclosed between the information processing device 10 and the information processing device 20.

### (First Prediction Model)

The first prediction model is a local model trained by an information processing device 10A in order to obtain, by federated learning, a model for predicting the effect of intervention on the subject based on the third feature converted from the first feature representing the subject. The first prediction model may include, for example, a third prediction model that predicts a result in a case where there is intervention based on the third feature, and a fourth prediction model that predicts a result in a case where there is no intervention based on the third feature. In this case, information obtained by subtracting the output of the fourth prediction model from the output of the third prediction model may be output from the first prediction model as the effect of the intervention.

In a case where the “intervention situation” includes only the presence or absence of intervention, the input of the third prediction model and the fourth prediction model may be only the “third feature”. In a case where the “intervention situation” includes situations other than the presence or absence of intervention such as the type of intervention, the degree of intervention, and the like, the input of the third prediction model that predicts the result in a case where there is intervention may include the intervention situation in addition to the third feature.

For example, the first prediction model training unit 13 classifies each set of the third feature obtained by converting the first feature included in the first input information and the result into either the presence of intervention or the absence of intervention based on the intervention situation predicted by the first prediction unit 12. As a result, the third prediction model is trained using the set of the third feature and the result classified as the presence of intervention as the training data. In other words, when the third feature is input, the third prediction model is trained such that a result in a case where there is intervention is output. As described above, in a case where the intervention situation includes situations other than the presence or absence of the intervention, the third prediction model may be trained such that, when the third feature and the intervention situation are input, a result in a case where the intervention is present is output. The fourth prediction model is trained using a set of the third feature and the result classified as the absence of intervention as training data. In other words, when the third feature is input, the fourth prediction model is trained such that a result in a case where there is no intervention is output.

The first prediction model is trained with reference to the global model. “Training with reference to the global model” means, for example, training a parameter of the global model as an initial parameter of the first prediction model. For example, when the first prediction model includes the third prediction model and the fourth prediction model, the global model may include a first global model and a second global model to be described later. In this case, the third prediction model is trained based on the first global model, and the fourth prediction model is trained based on the second global model.

### (Second Prediction Model)

The second prediction model is a local model trained by an information processing device 20A in order to obtain, by federated learning, a model for predicting the effect of intervention on the subject based on the third feature converted from the second feature representing the subject. The second prediction model may include, for example, a fifth prediction model that predicts a result in a case where there is intervention based on the third feature, and a sixth prediction model that predicts a result in a case where there is no intervention based on the third feature. In this case, information obtained by subtracting the output of the sixth prediction model from the output of the fifth prediction model may be output from the second prediction model as the effect of the intervention.

In a case where the “intervention situation” includes only the presence or absence of intervention, the input of the fifth prediction model and the sixth prediction model may be only the “third feature”. In a case where the “intervention situation” includes situations other than the presence or absence of intervention such as the type of intervention, the degree of intervention, and the like, the input of the fifth prediction model that predicts the result in a case where there is intervention may include the intervention situation in addition to the third feature.

For example, the second prediction model training unit 23 classifies each set of the third feature converted from the second feature included in the second input information and the intervention situation into either the presence of intervention or the absence of intervention based on the intervention situation. As a result, the fifth prediction model is trained using a set of the third feature classified as the presence of intervention and the result predicted based on the third feature as the training data. In other words, when the third feature is input, the fifth prediction model is trained such that a result in a case where there is intervention is output. As described above, in a case where the intervention situation includes situations other than the presence or absence of the intervention, the fifth prediction model may be trained such that, when the third feature and the intervention situation are input, a result in a case where the intervention is present is output. The sixth prediction model is trained using a set of the third feature classified as the absence of intervention and the result predicted based on the third feature as training data. In other words, when the third feature is input, the sixth prediction model is trained such that a result in a case where there is no intervention is output.

The second prediction model is trained based on the global model. “Trained based on the global model” means that the parameters of the global model are trained as initial parameters of the second prediction model. For example, when the second prediction model includes the fifth prediction model and the sixth prediction model, the global model may include a first global model and a second global model to be described later. In this case, the fifth prediction model is trained based on the first global model, and the sixth prediction model is trained based on the second global model.

### (Global Model)

The global model is a model in which a first prediction model and a second prediction model are integrated in order to generate, by federated learning, a model that predicts an effect of intervention on a subject based on a third feature representing the subject. “Models are integrated” may be, for example, integration of parameters that define the models. That is, the global model is defined by the integrated parameters. The integration of the parameters may mean taking an average of the parameters, but is not limited thereto. In a case where the information processing system 1 includes a plurality of information processing devices 10, the global model is a model in which a plurality of first prediction models and a plurality of second prediction models are integrated. In a case where the information processing system 1 includes a plurality of information processing devices 20, the global model is a model in which the first prediction model and the plurality of second prediction models are integrated.

For example, the global model may include a first global model in which the third prediction model and the fifth prediction model are integrated, and a second global model in which the fourth prediction model and the sixth prediction model are integrated. In this case, information obtained by subtracting the output of the second global model from the output of the first global model may be output from the global model as the effect of the intervention.

The global model is not limited to including the first global model and the second global model. For example, when the third prediction model and the fourth prediction model are linear models, the first prediction model training unit 13 may calculate the first prediction model defined by a parameter obtained by subtracting the parameter of the fourth prediction model from the parameter of the third prediction model. For example, when the fifth prediction model and the sixth prediction model are linear models, the second prediction model training unit 23 may calculate the second prediction model defined by a parameter obtained by subtracting the parameter of the sixth prediction model from the parameter of the fifth prediction model.

### (Effects of Information Processing System 1)

As described above, the information processing system 1 includes the information processing devices 10 and 20, the information processing device 10 includes the first acquisition unit 11, the first prediction unit 12, and the first prediction model training unit 13 described above, and the information processing device 20 includes the second acquisition unit 21, the second prediction unit 22, and the second prediction model training unit 23 described above.

Therefore, according to the information processing system 1, the information processing device 10 can obtain the prediction model (the first prediction model or the global model) that predicts the effect of the intervention on the subject from the third feature related to the subject without needing to know the second feature and the intervention situation related to the subject that cannot be acquired by the own device and without disclosing the first feature and the result for the subject acquired by the own device to the information processing device 20. Here, since the third feature can be converted from the first feature, in other words, the information processing device 10 can predict the effect of the intervention regarding the subject based on the first feature representing the subject. The information processing device 20 can obtain a prediction model (the second prediction model or the global model) that predicts the effect of the intervention on the subject from the third feature related to the subject without needing to know the first feature and the result for the subject that cannot be acquired by the own device and without disclosing the second feature and the intervention situation related to the subject acquired by the own device to the information processing device 10. Here, since the third feature can be converted from the second feature, in other words, the information processing device 20 can predict the effect of the intervention regarding the subject based on the second feature representing the subject. As a result, according to the information processing system 1, in a case where the intervention situation related to the subject and the result obtained for the subject cannot be acquired in association with each other, and the feature that can be acquired together with the intervention situation and the feature that can be acquired together with the result are different, the effect of the intervention can be predicted from each of the first feature and the second feature.

### (Flow of Information Processing Method S1)

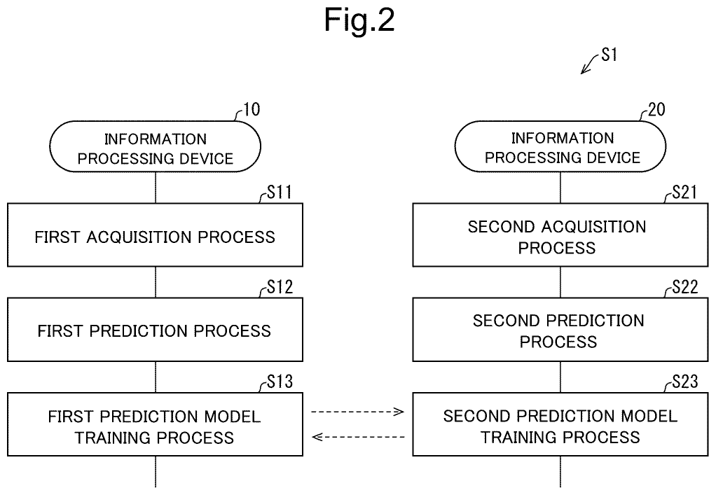

A flow of an information processing method S1 will be described with reference to FIG. 2. For example, in a case where each of the information processing devices 10 and 20 described above includes at least one processor, the information processing system 1 executes the information processing method S1. FIG. 2 is a flowchart illustrating a flow of the information processing method S1. As illustrated in FIG. 2, the information processing method S1 includes a first acquisition process S11, a first prediction process S12, a first prediction model training process S13, a second acquisition process S21, a second prediction process S22, and a second prediction model training process S23.

In the first acquisition process S11, at least one processor (for example, the first acquisition unit 11) included in the information processing device 10 acquires a first feature representing a subject and a result obtained for the subject. In other words, the first input information is acquired.

In the first prediction process S12, at least one processor (for example, the first prediction unit 12) included in the information processing device 10 predicts, based on the first feature representing the subject included in the first input information, the intervention situation that could have affected the result for the subject.

In the first prediction model training process S13, at least one processor (for example, the first prediction model training unit 13) included in the information processing device 10 trains the prediction model that predicts the effect of the intervention by the federated learning by the information processing devices 10 and 20 based on the third feature converted from the first feature, the result, and the intervention situation. For example, with the first input information and the predicted intervention situation as training data, the at least one processor trains, by machine learning, the first prediction model that predicts an effect of intervention on a subject based on the third feature converted from the first feature representing the subject with reference to a model in which the first prediction model and the second prediction model trained by the information processing device 20 are integrated. Here, the third feature is a feature converted from the first feature and the second feature such that feature distributions are similar in the same feature space.

In the second acquisition process S21, at least one processor (for example, the second acquisition unit 21) included in the information processing device 20 acquires the second feature representing the subject and the intervention situation related to the subject. In other words, the second input information is acquired.

In the second prediction process S22, at least one processor (for example, the second prediction unit 22) included in the information processing device 20 predicts the result for the subject based on the second feature representing the subject included in the second input information.

In the second prediction model training process S23, at least one processor (for example, the second prediction model training unit 23) included in the information processing device 20 trains the prediction model that predicts the effect of the intervention by the federated learning by the information processing devices 10 and 20 based on the third feature converted from the second feature, the result, and the intervention situation. For example, using the second input information and the predicted result as training data, the at least one processor trains, by machine learning, the second prediction model that predicts the effect of intervention on the subject based on the third feature converted from the second feature representing the subject with reference to a model in which the second prediction model and the first prediction model trained by the information processing device 10 are integrated. Here, the third feature is a feature converted from the first feature and the second feature such that feature distributions are similar in the same feature space.

The information processing device 10 repeatedly executes at least the first prediction model training process S13. For example, the information processing device 10 may repeat a series of processes including the first prediction process S12 and the first prediction model training process S13, or may repeat the first prediction model training process S13 without repeating the first prediction process S12. The information processing device 20 repeatedly executes at least the second prediction model training process S23. For example, the information processing device 20 may repeat a series of processes including the second prediction process S22 and the second prediction model training process S23, or may repeat the second prediction model training process S23 without repeating the second prediction process S22.

In the first prediction model training process S13 and the second prediction model training process S23, a model obtained by integrating the first prediction model and the second prediction model after training in each of the previous processes S13 and S23 is referred to as a new global model. In each of the processes S13 and S23, the same new global model is referred to, and training of the first prediction model and training of the second prediction model are performed. In the first first prediction model training process S13 and the first second prediction model training process S23, the same initial global model is referred to.

The process of integrating the first prediction model and the second prediction model to generate a new global model may be performed by any one of the information processing device 10 and the information processing device 20. For example, in a case where the information processing device 10 performs the process, the information processing device 10 may generate a new global model by integrating the first prediction model after training in the own device and the second prediction model after training received from the information processing device 20. The information processing device 10 may transmit a new global model to the information processing device 20. In a case where the information processing device 20 performs the process, the information processing devices 10 and 20 are replaced with each other and the first prediction model and the second prediction model are replaced with each other in the above description of a case where the information processing device 10 performs the process, and the same description will be given.

The process of integrating the first prediction model and the second prediction model to generate a new global model may be performed by a server (not illustrated) different from any of the information processing devices 10 and 20. In this case, the server may generate a new global model by integrating the trained first prediction model received from the information processing device 10 and the trained second prediction model received from the information processing device 20, and transmit the new global model to each of the information processing devices 10 and 20.

In this manner, (i) the information processing device 10 trains the first prediction model with reference to the global model, and the information processing device 20 trains the second prediction model with reference to the global model, and (ii) a model in which the first prediction model and the second prediction model are integrated repeatedly becomes a new global model. The repetition may be performed a predetermined number of times, for example, or may be performed until the first prediction model, the second prediction model, or the global model with predetermined accuracy is obtained.

### (Effect of Information Processing Method S1)

As described above, the information processing method S1 employs a configuration including the first acquisition process S11, the first prediction process S12, the first prediction model training process S13, the second acquisition process S21, the second prediction process S22, and the second prediction model training process S23 described above.

Therefore, according to the information processing method S1, the same effects as those of the information processing system 1 can be obtained.

### (Configuration of Information Processing Device 10)

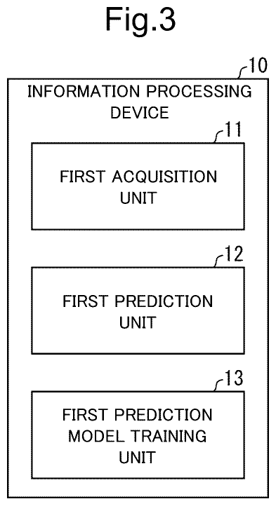

FIG. 3 is a block diagram illustrating a configuration of the information processing device 10. The information processing device 10 is an example of a configuration that implements the information processing device according to an exemplary aspect of the present disclosure. As illustrated in FIG. 3, the information processing device 10 includes a first acquisition unit 11, a first prediction unit 12, and a first prediction model training unit 13. The first acquisition unit 11 is an example of a configuration that implements an acquisition means. The first prediction unit 12 is an example of a configuration that implements a prediction means. The first prediction model training unit 13 is an example of a configuration that implements a prediction model training means. The first feature is an example of a “feature representing a subject”. The second feature is an example of “another feature acquired for the subject by another information processing device”. The third feature is an example of a “feature after conversion”. Since the details of the first acquisition unit 11, the first prediction unit 12, and the first prediction model training unit 13 are as described above, the description thereof will not be repeated.

### (Effects of Information Processing Device 10)

As described above, the information processing device 10 employs a configuration including the first acquisition unit 11, the first prediction unit 12, and the first prediction model training unit 13 described above. Therefore, according to the information processing device 10, it is possible to obtain the prediction model (the first prediction model or the global model) that predicts the effect of the intervention on the subject from the third feature representing the subject without needing to know the second feature and the intervention situation related to the subject that cannot be acquired by the own device and without externally disclosing the first feature and the result for the subject acquired by the own device. Here, since the third feature can be converted from the first feature, in other words, the information processing device 10 can predict the effect of the intervention from the first feature representing the subject.

### (Flow of Information Processing Method S10)

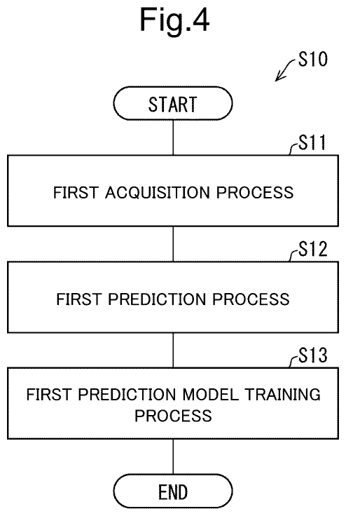

A flow of an information processing method S10 will be described with reference to FIG. 4. For example, in a case where the information processing device 10 described above includes at least one processor, the information processing device 10 executes the information processing method S10. FIG. 4 is a flowchart illustrating a flow of the information processing method S10. As illustrated in FIG. 4, the information processing method S10 includes a first acquisition process S11 (an example of acquisition process), a first prediction process S12 (an example of prediction process), and first prediction model training process S13 (an example of prediction model training process). Since the details of the first acquisition process S11, the first prediction process S12, and the first prediction model training process S13 are as described above, the description thereof will not be repeated.

The at least one processor repeatedly executes at least the first prediction model training process S13. For example, the at least one processor may repeat a series of processes including the first prediction process S12 and the first prediction model training process S13, or may repeat the first prediction model training process S13 without repeating the first prediction process S12.

### (Effect of Information Processing Method S10)

As described above, in the information processing method S10, a configuration including the first acquisition process S11, the first prediction process S12, and the first prediction model training process S13 described above is adopted. Therefore, according to the information processing method S10, the same effects as those of the information processing device 10 can be obtained.

### (Configuration of Information Processing Device 20)

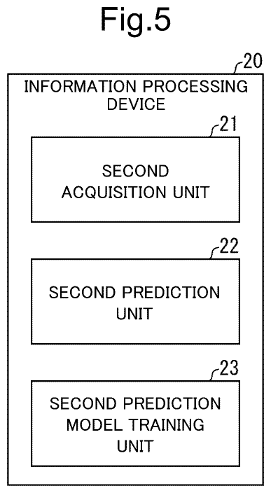

FIG. 5 is a block diagram illustrating a configuration of the information processing device 20. The information processing device 20 is an example of a configuration that implements the information processing device according to an exemplary aspect of the present disclosure. As illustrated in FIG. 5, the information processing device 20 includes a second acquisition unit 21, a second prediction unit 22, and a second prediction model training unit 23. The second acquisition unit 21 is an example of a configuration that implements an acquisition means. The second prediction unit 22 is an example of a configuration that implements a prediction means. The second prediction model training unit 23 is an example of a configuration that implements a prediction model training means. The first feature is an example of “another feature acquired for the subject by another information processing device”. The second feature is an example of a “feature representing a subject”. The third feature is an example of a “feature after conversion”. Since the details of the second acquisition unit 21, the second prediction unit 22, and the second prediction model training unit 23 are as described above, the description thereof will not be repeated.

### (Effects of Information Processing Device 20)

As described above, the information processing device 20 employs a configuration including the second acquisition unit 21, the second prediction unit 22, and the second prediction model training unit 23 described above. Therefore, according to the information processing device 20, it is possible to obtain the prediction model (the second prediction model or the global model) that predicts the effect of the intervention on the subject from the third feature related to the subject without needing to know the first feature and the result obtained for the subject that cannot be acquired by the own device and without externally disclosing the second feature and the intervention situation related to the subject acquired by the own device. Here, since the third feature can be converted from the second feature, in other words, the information processing device 20 can predict the effect of the intervention from the second feature representing the subject.

### (Flow of Information Processing Method S20)

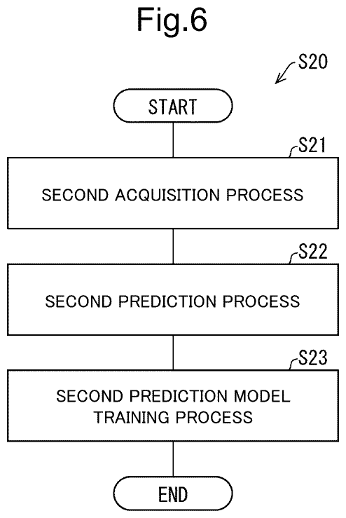

A flow of an information processing method S20 will be described with reference to FIG. 6. For example, in a case where the information processing device 20 described above includes at least one processor, the information processing device 20 executes the information processing method S20. FIG. 6 is a flowchart illustrating a flow of the information processing method S20. As illustrated in FIG. 6, the information processing method S20 includes a second acquisition process S21 (an example of acquisition process), a second prediction process S22 (an example of prediction process), and a second prediction model training process S23 (an example of prediction model training process). Since the details of the second acquisition process S21, the second prediction process S22, and the second prediction model training process S23 are as described above, the description thereof will not be repeated.

The at least one processor repeatedly executes at least the second prediction model training process S23. For example, the at least one processor may repeat a series of processes including the second prediction process S22 and the second prediction model training process S23, or may repeat the second prediction model training process S23 without repeating the second prediction process S22.

### (Effect of Information Processing Method S20)

As described above, in the information processing method S20, a configuration including the second acquisition process S21, the second prediction process S22, and the second prediction model training process S23 described above is adopted. Therefore, according to the information processing method S20, the same effects as those of the information processing device 20 can be obtained.

### Second Example Embodiment

A second example embodiment that is an example of an example embodiment of the present disclosure will be described in detail with reference to the drawings. Constituents that have the same functions as the constituents described in the above-described example embodiment are denoted by the same reference numerals, and the description of the constituents will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in each of the drawings referred to for describing the present example embodiment can be employed in the other example embodiments included in the present disclosure within a range in which no particular technical problem occurs.

### (Outline of Information Processing System 1A)

An information processing system 1A is configured as follows in addition to the same configuration as the information processing system 1. In the information processing system 1A, the information processing devices 10A and 20A cooperatively train a first conversion model that converts a first feature representing a subject into a third feature and a second conversion model that converts a second feature representing the subject into a third feature. In the information processing system 1A, a result prediction model trained by the information processing device 10A capable of acquiring a result for a subject and an intervention prediction model trained by the information processing device 20A capable of acquiring an intervention situation related to the subject are exchanged between the information processing devices 10A and 20A.

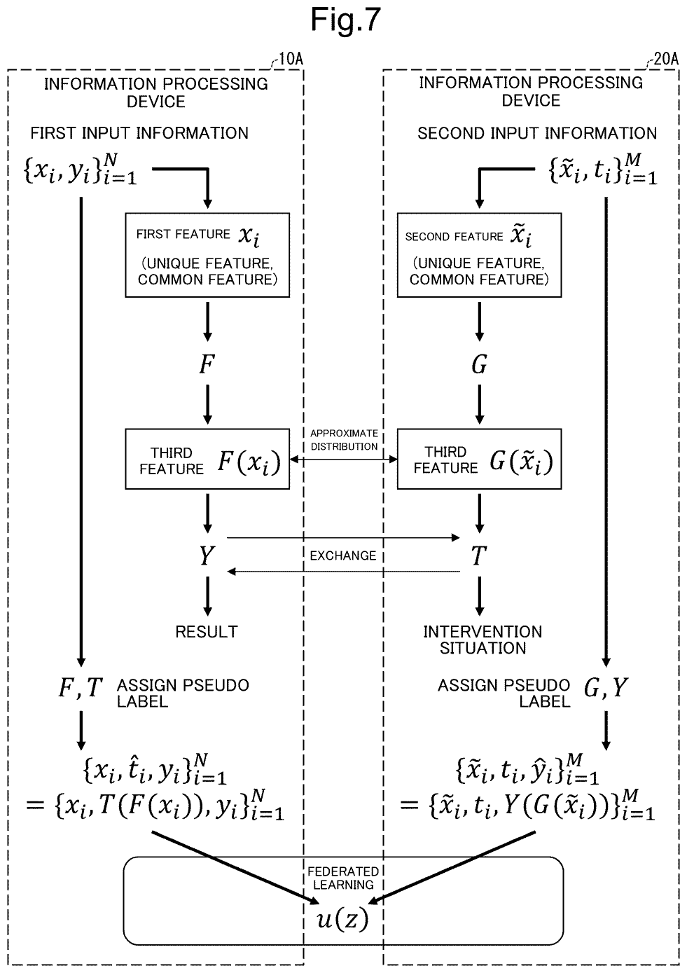

FIG. 7 is a diagram schematically illustrating an outline of the information processing system 1A. In the following, the subscript (for example, i) illustrated in FIG. 7 is described as “_i” or the like by adding an under-bar to the subscript. A tilde symbol (˜) attached to an upper portion of a character (for example, x) is described as “x˜” or the like by continuing the tilde symbol to the character. A hat symbol (\hat{ }) attached to an upper portion of a character (for example, t) is described as “t\hat{ }” or the like by continuing the hat symbol to the character.

In FIG. 7, the information processing device 10A is a device capable of acquiring a first feature x_i representing a subject and a result y_i for the subject. N sets (N is a natural number greater than or equal to 2, i=1, 2, . . . , N) of the first feature x_i and the result y_i are input to the information processing device 10A as the first input information. The information processing device 20A is a device capable of acquiring a second feature x˜_i related to the subject and an intervention situation t_i related to the subject. M sets (M is a natural number greater than or equal to 2) of the second feature x˜_i and the intervention situation t_i are input to the information processing device 20A as the second input information.

The first feature x_i and the second feature x˜_i include at least different unique features. The first feature x_i and the second feature x˜_i may include a common feature.

The first feature x_i and the second feature x˜_i are information that are not disclosed to each other. The first feature x_i and the second feature x˜_i are not necessarily features related to the same subject (for example, the same user).

The information processing device 10A trains, by machine learning, the first conversion model “F” that converts the feature x_i included in the first input information into the third feature. The information processing device 20A trains, by machine learning, the first conversion model “G” that converts the features x˜_i included in the second input information into the third feature. Here, the training of the first conversion model “F” and the training of the second conversion model “G” are performed in cooperation under the constraint that the distributions of the third features to be output are made approximated.

Here, for example, a method of exchanging statistical information, a method based on adversarial learning, and the like can be cited as a specific example of a method of approximating the distribution of the third feature. In the method for exchanging statistical information, the information processing devices 10A and 20A (first conversion model training unit 15 and second conversion model training unit 25 to be described later) each calculate and exchange statistical information of the third feature. Examples of the statistical information include, but are not limited to, average and covariance. The information processing device 10A performs training of the first conversion model so as to reduce the difference in the statistical information by including a term relevant to the difference (for example, the average difference and the covariance difference) in the statistical information in the loss function.

Similarly, the information processing device 20A performs training of the second conversion model so as to reduce the difference in the statistical information by including a term relevant to the difference in the statistical information in the loss function. The difference in the statistical information is a difference between the statistical information calculated by the information processing device 10A and the statistical information calculated by the information processing device 20A. For example, the difference between the averages is a difference between the average calculated by the information processing device 10A and the average calculated by the information processing device 20A. For example, the difference in covariance is a difference between the covariance calculated by the information processing device 10A and the covariance calculated by the information processing device 20A.

In the method based on adversarial learning, the information processing devices 10A and 20A train identification models for identifying from which of the first feature and the second feature the third feature has been converted, in cooperation. The information processing device 10A trains the first conversion model so as to output the third feature that causes the identification model to perform erroneous identification. The information processing device 20A trains the second conversion model so as to output the third feature that causes the identification model to perform erroneous identification. The method for approximating the distribution of the third feature is not limited to the above-described method.

The information processing device 10A trains a result prediction model “Y” such that the third feature F(x_i) obtained by converting the first feature x_i included in the first input information by the first conversion model “F” and the result y_i included in the first input information are used as training data, and when the F(x_i) is input, the result y_i is output.

The information processing device 20A trains an intervention prediction model “T” such that the third feature G(x˜_i) obtained by converting the second feature x˜_i included in the second input information by the second conversion model “G” and the intervention situation t_i included in the second input information are used as training data, and the t_i is output when the G(x˜_i) is input. The result prediction model “Y” and the intervention prediction model “T” are exchanged between the information processing devices 10A and 20A.

The information processing device 10A calculates “T(F(x_i))” using the trained first conversion model “F” and the intervention prediction model “T” obtained by the exchange, and assigns the calculated “T(F(x_i))” to the first input information as a pseudo label “t\hat{ }_i” indicating the intervention situation. As a result, N sets of the first feature x_i representing the subject, the pseudo label t\hat{ }_i, and the result y_i are obtained. The information processing device 20A calculates “Y(G(x˜_i))” using the trained second conversion model “G” and the result prediction model “Y” obtained by the exchange, and assigns the “Y(G(x˜_i))” to the second input information as a pseudo label “y\hat{ }_i” indicating a result. As a result, M sets of the second feature x˜_i representing the subject, the intervention situation t\hat{ }_i, and the pseudo label y_i indicating the result are obtained.

Each of the information processing devices 10A and 20A can use three sets as training data, and as a result, can generate a prediction model “u(z)” by federated learning. The prediction model u(z) is a model that outputs the intervention effect “u(z)” using the third feature “z” representing the subject as an input.

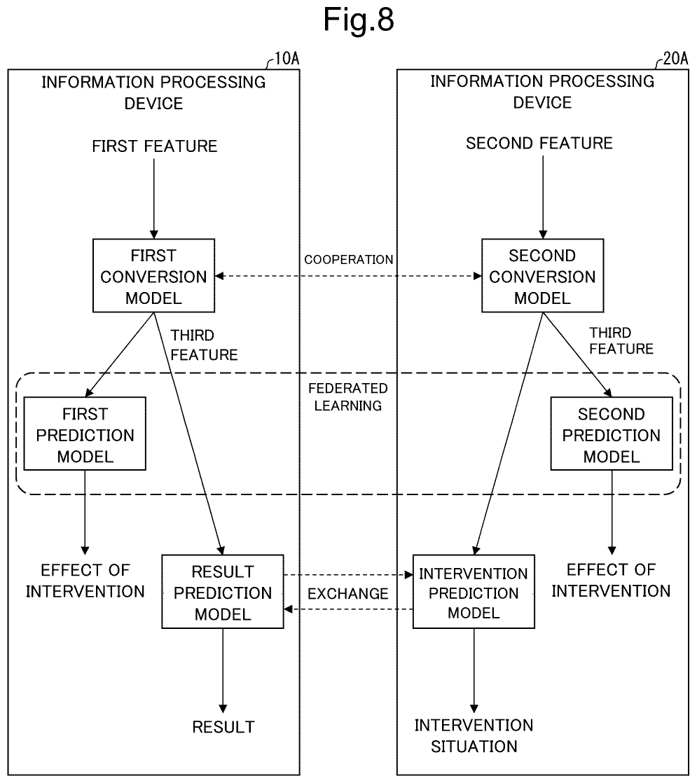

FIG. 8 is a diagram schematically illustrating a relationship among the first conversion model, the first prediction model, the result prediction model, the second conversion model, the second prediction model, and the intervention prediction model. As illustrated in FIG. 8, the first conversion model outputs the third feature with the first feature that can be acquired by the information processing device 10A as an input. The result prediction model outputs a result with the third feature as an input. The first prediction model outputs the effect of the intervention using the third feature as an input. The second conversion model outputs the third feature with the second feature that can be acquired by the information processing device 20A as an input. The intervention prediction model outputs the intervention situation using the third feature as an input. The second prediction model outputs the effect of the intervention using the third feature as an input. Federated learning is performed using the first prediction model and the second prediction model as local models. The result prediction model and the intervention prediction model are exchanged between the information processing devices 10A and 20A, and are used for training of the first prediction model and the second prediction model.

### (Configuration of Information Processing System 1A)

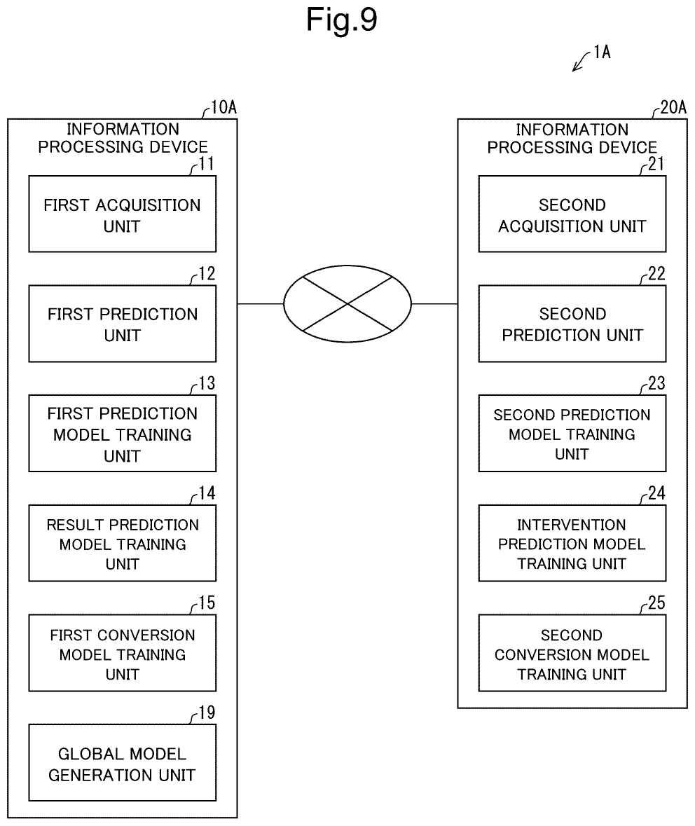

Next, a configuration of the information processing system 1A will be described with reference to FIG. 9. FIG. 9 is a block diagram illustrating a configuration of the information processing system 1A. The information processing system 1A includes information processing devices 10A and 20A. The information processing device 10A includes a result prediction model training unit 14, a first conversion model training unit 15, and a global model generation unit 19 in addition to the first acquisition unit 11, the first prediction unit 12, and the first prediction model training unit 13 included in the information processing device 10. The information processing device 20A includes an intervention prediction model training unit 24 and a second conversion model training unit 25 in addition to the second acquisition unit 21, the second prediction unit 22, and the second prediction model training unit 23 included in the information processing device 20. The result prediction model training unit 14 is an example of a configuration that implements a result prediction model training means. The first conversion model training unit 15 is an example of a configuration that implements a first conversion model training means. The intervention prediction model training unit 24 is an example of a configuration that implements an intervention prediction model training means. The second conversion model training unit 25 is an example of a configuration that implements a second conversion model training means.

The first conversion model training unit 15 trains the first conversion model that converts the first feature into the third feature. In the training of the first conversion model, for example, the first feature included in the first input information is used as training data. The second conversion model training unit 25 trains the second conversion model that converts the second feature into the third feature. In the training of the second conversion model, for example, the second feature included in the second input information is used as training data. The training of the first conversion model and the training of the second conversion model are performed in cooperation under the constraint that the distribution of the third feature to be output is approximated. The specific example of the method of approximating the distribution of the third feature is as described above, and details are not described herein again.

The result prediction model training unit 14 trains a result prediction model that predicts a result for a subject from the third feature representing the subject. For example, the result prediction model training unit 14 may use the first input information as training data and convert the first feature included in the first input information into the third feature using the first conversion model to train, by machine learning, a result prediction model that predicts a result for the subject based on the third feature representing the subject. In other words, when the third feature converted from the first feature included in the first input information is input, the result prediction model is trained such that the result included in the first input information is output. The result prediction model training unit 14 provides the result prediction model to the information processing device 20A.

The intervention prediction model training unit 24 trains an intervention prediction model that predicts an intervention situation related to a subject from the third feature representing the subject. For example, the intervention prediction model training unit 24 may use the second input information as training data to convert the second feature included in the second input information into the third feature using the second conversion model to train, by machine learning, an intervention prediction model that predicts the intervention situation related to the subject based on the third feature representing the subject. In other words, when the third feature converted from the second feature included in the second input information is input, the intervention prediction model is trained such that the intervention situation included in the second input information is output. The intervention prediction model training unit 24 provides the intervention prediction model to the information processing device 10A.

The first prediction unit 12 is configured as follows in addition to being configured similarly to the first prediction unit 12 included in the information processing device 10. The first prediction unit 12 predicts the intervention situation related to the subject using the first conversion model trained by the first conversion model training unit 15 and the intervention prediction model provided from the information processing device 20A. For example, the first prediction unit 12 converts the first feature representing each of the plurality of subjects included in the first input information into the third feature by the first conversion model, and inputs the third feature to the intervention prediction model, thereby acquiring the intervention situation output from the intervention prediction model.

The second prediction unit 22 is configured as follows in addition to being configured similarly to the second prediction unit 22 included in the information processing device 20. The second prediction unit 22 predicts a result for the subject using the second conversion model trained by the second conversion model training unit 25 and the result prediction model provided from the information processing device 10A. For example, the second prediction unit 22 converts the second feature representing each of the plurality of subjects included in the second input information into the third feature by the second conversion model, and inputs the third feature to the result prediction model, thereby acquiring the result output from the result prediction model.

Here, the training of the first conversion model, the training of the result prediction model, and the training of the prediction model are performed independently of each other. In other words, the training of the first conversion model, the training of the result prediction model, and the training of the first prediction model, which is a local model in the federated learning for generating the prediction model, are performed independently of each other. As a result, for example, the training of the first conversion model and the result prediction model can be completed before starting the training of the first prediction model. The result prediction model for which training has been completed can be provided to the information processing device 20A before starting training of the second prediction model.

The training of the second conversion model, the training of the intervention prediction model, and the training of the prediction model are performed independently of each other. In other words, the training of the second conversion model, the training of the intervention prediction model, and the training of the second prediction model, which is a local model in the federated learning for generating the prediction model, are performed independently of each other. As a result, for example, the training of the second conversion model and the intervention prediction model can be completed before starting the training of the second prediction model. The intervention prediction model for which training has been completed can be provided to the information processing device 10A before the start of training of the first prediction model.

As a result, before starting training of the first prediction model, the information processing device 10A can accurately predict the “intervention situation” necessary for the training using the first conversion model for which the training has been completed and the intervention prediction model for which the training has been completed. Before starting training of the second prediction model, the information processing device 20A can predict the “result” necessary for the training using the second conversion model for which the training has been completed and the result prediction model for which the training has been completed.

The global model generation unit 19 generates an initial global model and provides the initial global model to the first prediction model training unit 13 and the second prediction model training unit 23. The initial global model is defined by initial parameters. The global model generation unit 19 generates a new global model obtained by integrating the first prediction model and the second prediction model, and provides the new global model to the first prediction model training unit 13 and the second prediction model training unit 23.

### (Flow of Information Processing Method S1A)

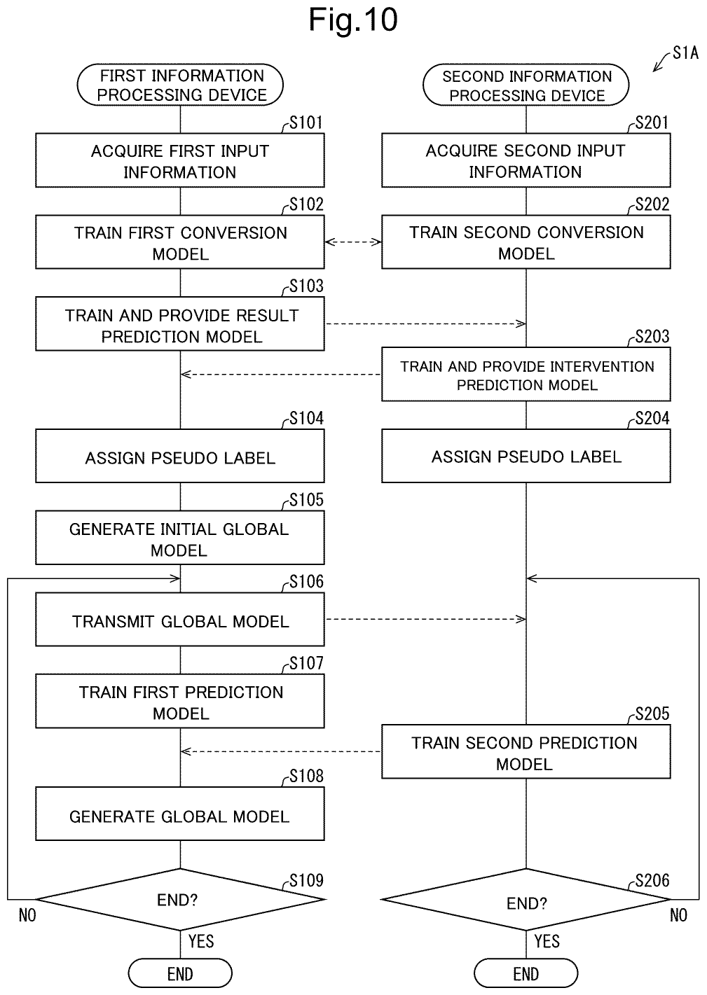

A flow of an information processing method SIA will be described with reference to FIG. 10. For example, in a case where each of the information processing devices 10A and 20A described above includes at least one processor, the information processing system 1A executes the information processing method SIA. FIG. 10 is a flowchart illustrating a flow of the information processing method SIA. As illustrated in FIG. 10, the information processing method SIA includes steps S101 to S109 executed by the information processing device 10A and S201 to S206 executed by the information processing device 20A.

In step S101, the first acquisition unit 11 acquires first input information including a first feature representing a subject and a result for the subject. Step S101 is an example of a first acquisition process.

In step S201, the second acquisition unit 21 acquires the second input information including the second feature representing the subject and the intervention situation related to the subject. Step S201 is an example of a second acquisition process. The execution order of steps S101 and S201 is not limited to this order, and is in any order.

The “execution order of the plurality of steps is in any order” includes executing each step in an arbitrary order, executing some or all of the steps in parallel, and the like.

In step S102, the first conversion model training unit 15 trains the first conversion model. Step S102 is an example of a first conversion model training process. In step S202, the second conversion model training unit 25 trains the second conversion model. Step S202 is an example of a second conversion model training process. The training of the first conversion model and the training of the second conversion model are performed in cooperation under the constraint that the distribution of the third feature to be output is approximated. Therefore, steps S102 and S202 are executed in parallel.

In step S103, the result prediction model training unit 14 converts the first feature included in the first input information into the third feature using the first conversion model. When the third feature is input, the result prediction model training unit 14 trains the result prediction model so that the result included in the first input information is output. The result prediction model training unit 14 transmits the trained result prediction model to the information processing device 20A. Step S103 is an example of a result prediction model training process.

In step S203, the intervention prediction model training unit 24 converts the second feature included in the second input information into the third feature using the second conversion model. When the third feature is input, the intervention prediction model training unit 24 trains the intervention prediction model so that the intervention situation included in the second input information is output. The intervention prediction model training unit 24 transmits the trained intervention prediction model to the information processing device 10A. Step S203 is an example of an intervention prediction model training process. The execution order of steps S103 and S203 is not limited to this order, and is in any order.

In step S104, the first prediction unit 12 converts the first feature included in the first input information into the third feature using the first conversion model trained in step S102. The first prediction unit 12 inputs the converted third feature to the intervention prediction model received from the information processing device 20A in step S203, thereby predicting the intervention situation related to the subject indicated by the third feature. As a result, a pseudo label indicating the predicted intervention situation is given to the first feature representing each of the plurality of subjects included in the first input information. Step S104 is an example of a first prediction process.

In step S204, the second prediction unit 22 converts the second feature included in the second input information into the third feature using the second conversion model trained in step S202. The second prediction unit 22 inputs the converted third feature to the result prediction model received from the information processing device 10A in step S103, thereby predicting a result for the subject indicated by the third feature. As a result, a pseudo label indicating a predicted result is given to the second feature representing each of the plurality of subjects included in the second input information. Step S204 is an example of a second prediction process. The execution order of steps S104 and S204 is not limited to this order, and is in any order.

In step S105, the global model generation unit 19 generates an initial global model. In other words, the global model generation unit 19 sets initial parameters that define the global model. Step S105 may be performed before step S106 is performed, and may not necessarily be performed after step S104.

In step S106, the global model generation unit 19 transmits the global model to the information processing device 20A.

In step S107, the first prediction model training unit 13 trains the first prediction model with reference to the global model using the pseudo label indicating the first input information and the intervention situation as training data. Step S107 is an example of a first prediction model training process. Details of the training of the first prediction model are as described in the first example embodiment, and thus, the description thereof will not be repeated.

In step S107, the first conversion model may be retrained in parallel with the training of the first prediction model. For example, by training a model connected so as to input the output of the first conversion model to the first prediction model such that the effect of the intervention is output when the first feature is input, the first prediction model can be trained and the first conversion model can be retrained. The retraining of the first conversion model is performed under the constraint that the distribution of the third feature to be output is approximated by cooperation with the retraining of the second conversion model to be described later.

In step S205, the second prediction model training unit 23 trains the second prediction model with reference to the global model using the pseudo label indicating the second input information and the result as training data. Step S205 is an example of a second prediction model training process. Details of the training of the second prediction model are as described in the first example embodiment, and thus, the description thereof will not be repeated.

In step S205, the second conversion model may be retrained in parallel with the training of the second prediction model. For example, by training a model connected so as to input the output of the second conversion model to the second prediction model such that the effect of the intervention is output when the second feature is input, the second prediction model can be trained and the second conversion model can be retrained. The retraining of the second conversion model is performed under the constraint that the distribution of the output third feature is approximated by cooperation with the above-described retraining of the first conversion model.

The second prediction model training unit 23 transmits the trained second prediction model to the information processing device 10A. The execution order of steps S107 and S205 is not limited to this order, and is in any order.

In step S108, the global model generation unit 19 generates a new global model obtained by integrating the first prediction model after training in step S107 and the second prediction model received from the information processing device 20A in step S205.

In step S109, the information processing device 10A determines whether to end the federated learning. In a case where it is determined that the learning is not ended, the information processing device 10A repeats the process from step S106. The information processing device 10A may determine whether to end the federated learning based on whether the number of repetitions has reached a predetermined number of times, or based on whether the accuracy of the first prediction model (or the global model) has exceeded a threshold value. However, the viewpoint of determining whether to end the federated learning is not limited to these examples.

The global model transmitted to the information processing device 20A in the next step S106 is a new global model generated in the previous step S108 and obtained by integrating the first prediction model and the second prediction model. In the next step S107, the first prediction model is trained with reference to the “new global model obtained by integrating the first prediction model and the second prediction model”. In each repeated step S107 (first prediction model training process), a pseudo label indicating the intervention situation given in advance in step S104 is referred to.

In step S206, the information processing device 20A determines whether to end the federated learning. In a case where it is determined that the learning is not ended, the information processing device 20A repeats the process from step S205. The information processing device 20A may determine whether to end the federated learning based on whether the number of repetitions has reached a predetermined number of times, or based on whether the accuracy of the second prediction model (or the global model) has exceeded a threshold value. However, the viewpoint of determining whether to end the federated learning is not limited to these examples.

In the next step S205, the second prediction model is trained with reference to the “new global model obtained by integrating the first prediction model and the second prediction model” received from the information processing device 10A. In each repeated step S205 (second prediction model training process), a pseudo label indicating a result given in advance in step S204 is referred to.

In a case where it is determined in step S109 or S206 that the learning is ended, the information processing method SIA ends. As a result, the information processing device 10A can obtain the first prediction model (or the global model) that predicts the effect of the intervention on the subject based on the third feature representing the subject. As a result, the information processing device 10A can predict the effect of intervention on the subject based on the first feature representing the subject by using the first conversion model and the first prediction model (or the global model). The information processing device 20A can obtain a second prediction model (or global model) that predicts the effect of intervention on the subject based on the third feature representing the subject. As a result, the information processing device 20A can predict the effect of intervention on the subject based on the second feature representing the subject by using the second conversion model and the second prediction model (or the global model).

### Effects of Present Example Embodiment

As described above, in the information processing system 1A, the information processing device 10A further includes the first conversion model training unit 15 that trains the first conversion model that converts the first feature into the third feature, and the result prediction model training unit 14 that trains the result prediction model that predicts the result for the subject from the third feature representing the subject. The information processing device 20A further includes the second conversion model training unit 25 that trains the second conversion model that converts the second feature into the third feature, and the intervention prediction model training unit 24 that trains the intervention prediction model that predicts the intervention situation related to the subject from the third feature representing the subject. A configuration is adopted in which the first prediction unit 12 predicts the intervention situation related to the subject using the first conversion model and the intervention prediction model, and the second prediction unit 22 predicts the result for the subject using the second conversion model and the result prediction model. Therefore, according to the information processing system 1A, in addition to the effects exhibited by the information processing system 1, the information processing device 10A that cannot acquire the intervention situation related to the subject can accurately predict the intervention situation by using the intervention prediction model trained by the information processing device 20A that can acquire the intervention situation and the first conversion model trained by the own device. The information processing device 20A that cannot acquire the result for the subject can accurately predict the result by using the result prediction model trained by the information processing device 10A that can acquire the result and the second conversion model trained by the own device.

In the information processing system 1A, a configuration is adopted in which the first conversion model training unit 15 and the second conversion model training unit 25 exchange the statistical information of the third feature and train the first conversion model and the second conversion model so as to reduce the difference by including the term relevant to the difference in the statistical information in the loss function. Therefore, according to the information processing system 1A, the feature distribution of the third feature converted from the first feature and the feature distribution of the third feature converted from the second feature can be accurately made similar, and the federated learning of the prediction model that predicts the effect of the intervention from the third feature can be accurately performed.

In the information processing system 1A, a configuration is adopted in which the first conversion model training unit 15 and the second conversion model training unit 25 cooperatively train an identification model that identifies from which of the first feature and the second feature the third feature has been converted, and train the first conversion model and the second conversion model so as to output the third feature that causes the identification model to perform erroneous identification. Therefore, according to the information processing system 1A, the feature distribution of the third feature converted from the first feature and the feature distribution of the third feature converted from the second feature can be accurately made similar, and the federated learning of the prediction model that predicts the effect of the intervention from the third feature can be accurately performed.

The information processing system 1A adopts a configuration in which training of the first conversion model, training of the result prediction model, and training of the prediction model are performed independently of each other, and training of the second conversion model, training of the intervention prediction model, and training of the prediction model are performed independently of each other. Therefore, according to the information processing system 1A, in addition to the effects exhibited by the information processing system 1, the federated learning for generating the prediction model (first prediction model, second prediction model, or global model) that predicts the effect of intervention on the subject based on the third feature representing the subject can be started using, as training data, the intervention situation and the result accurately predicted by the result prediction model and the intervention prediction model for which training has been completed, and as a result, an effect that convergence is fast can be obtained.

### [First Modification]

The information processing system 1A described above can be further modified as follows. The first conversion model training unit 15, the result prediction model training unit 14, and the first prediction model training unit 13 train the first conversion model, the result prediction model, and the prediction model in parallel while sharing the output from the first conversion model as inputs of the result prediction model and the prediction model. In other words, the first conversion model, the result prediction model, and the first prediction model are trained in parallel while sharing the output from the first conversion model as inputs of the result prediction model and the first prediction model that is a local model in the federated learning for generating the prediction model.

The second conversion model training unit 25, the intervention prediction model training unit 24, and the second prediction model training unit 23 train the second conversion model, the intervention prediction model, and the prediction model in parallel while sharing the output from the second conversion model as inputs of the intervention prediction model and the prediction model.

In other words, the second conversion model, the intervention prediction model, and the second prediction model are trained in parallel while sharing the output from the second conversion model as inputs of the intervention prediction model and the second prediction model that is a local model in the federated learning for generating the prediction model.

For example, the first conversion model, the result prediction model, and the first prediction model illustrated in FIG. 8 are trained in parallel in the information processing device 10A. The second conversion model, the intervention prediction model, and the second prediction model are trained in parallel in the information processing device 20A. Among them, since the first prediction model and the second prediction model are subjects of federated learning, a global model in which the first prediction model and the second prediction model are integrated is obtained. In the next cycle, the first conversion model and the result prediction model trained in the previous cycle, and the first prediction model to which the global model is applied are trained in parallel. The second conversion model and the intervention prediction model trained in the previous cycle, and the second prediction model to which the global model is applied are trained in parallel. Then, a global model in which the first prediction model and the second prediction model are integrated is repeatedly obtained.

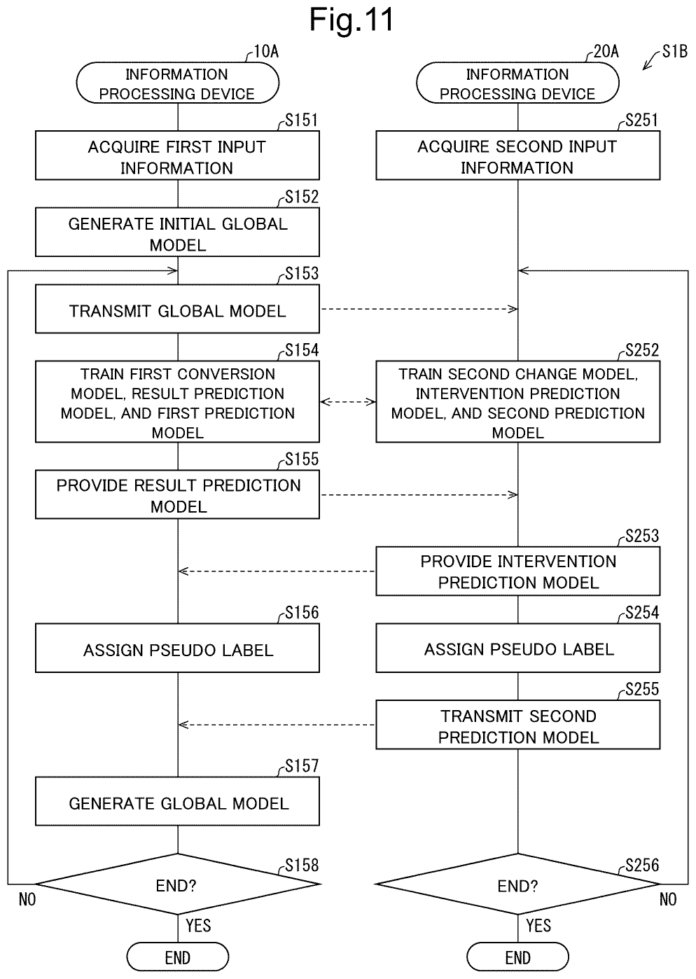

In the present modification, an information processing method S1B is executed instead of the information processing method SIA illustrated in FIG. 10. FIG. 11 is a flowchart illustrating a flow of the information processing method SIB. As illustrated in FIG. 11, the information processing method S1B includes steps S151 to S158 executed by the information processing device 10A and steps S251 to S256 executed by the information processing device 20A.

In step S151, the first acquisition unit 11 acquires the first input information. Step S151 is similar to step S101 described above.

In step S251, the second acquisition unit 21 acquires the second input information. Step S251 is similar to step S201 described above. The execution order of steps S151 and S251 is not limited to this order, and is in any order.

In step S152, the global model generation unit 19 generates an initial global model. Step S152 is similar to step S105 described above. Step S152 may be performed before step S153 is performed, and may not necessarily be performed after step S151.

In step S153, the global model generation unit 19 transmits the global model to the information processing device 20A. Step S153 is similar to step S105 described above.

In step S154, the first conversion model training unit 15, the result prediction model training unit 14, and the first prediction model training unit 13 of the information processing device 10A train the first conversion model, the result prediction model, and the first prediction model in parallel while sharing the output of the first conversion model as inputs of the first prediction model and the result prediction model. Among them, the training of the first prediction model is performed with reference to the global model. As training data for training these models in parallel, a pseudo label indicating first input information and an intervention situation is used. As the parallel training processing, a known multi-task learning method can be adopted.

Among the training performed in parallel in step S154, a pseudo label indicating the intervention situation is required for the training of the first prediction model, but the intervention prediction model required for giving the pseudo label has not yet been obtained when the execution of step S154 is the first time. In this case, the pseudo label may be given using an arbitrary intervention prediction model. The pseudo label in a case where the execution of step S154 is the second and subsequent times will be described later. In the first step S154, the training of the first prediction model may be omitted, and only the training of the first conversion model and the result prediction model may be performed.

In step S252, the second conversion model training unit 25, the intervention prediction model training unit 24, and the second prediction model training unit 23 of the information processing device 20A train the second conversion model, the intervention prediction model, and the second prediction model in parallel while sharing the output of the second conversion model as inputs of the second prediction model and the intervention prediction model. Among them, the training of the second prediction model is performed with reference to the global model. As training data for training these models in parallel, a pseudo label indicating the second input information and the result is used. As the parallel training processing, a known multi-task learning method can be adopted.

Among the training performed in parallel in step S252, a pseudo label indicating a result is required for training of the second prediction model, but the result prediction model required for giving the pseudo label has not yet been obtained when the execution of step S252 is the first time. In this case, the pseudo label may be given using an arbitrary result prediction model. In the first step S252, the training of the second prediction model may be omitted, and only the training of the second conversion model and the intervention prediction model may be performed. The pseudo label in a case where the execution of step S252 is the second and subsequent times will be described later. The execution order of steps S154 and S252 is not limited to this order, and is in any order.

In step S155, the result prediction model training unit 14 of the information processing device 10A transmits the trained result prediction model to the information processing device 20A.

In step S253, the intervention prediction model training unit 24 of the information processing device 20A transmits the trained intervention prediction model to the information processing device 10A. The execution order of steps S155 and S253 is not limited to this order, and is in any order.

In step S156, the first prediction unit 12 of the information processing device 10A uses the trained first conversion model and the received intervention prediction model to assign a pseudo label indicating the intervention situation to the first feature representing each of the plurality of subjects included in the first input information. The pseudo label given in this step is referred to when training the first prediction model in the next step S154.

In step S254, the second prediction unit 22 of the information processing device 20A assigns a pseudo label indicating a result to the second feature representing each of the plurality of subjects included in the second input information by using the trained second conversion model and the received result prediction model. The pseudo label given in this step is referred to when training the second prediction model in the next step S252. The execution order of steps S156 and S254 is not limited to this order, and is in any order.

In step S255, the second prediction model training unit 23 of the information processing device 20A transmits the trained second prediction model to the information processing device 10A.

In step S157, the global model generation unit 19 generates a global model in which the trained first prediction model and the received second prediction model are integrated.

In step S158, the information processing device 10A determines whether to end the federated learning. Since a specific example of determining whether to end the federated learning is similar to step S109, detailed description will not be repeated. In a case where it is determined that the learning is not ended, the information processing device 10A repeats the processing from step S153.

The global model transmitted to the information processing device 20A in the next step S153 is a new global model generated in the previous step S157 and obtained by integrating the first prediction model and the second prediction model. In the next step S154, the new global model becomes the first prediction model at the start of training. The first conversion model trained in the previous step S154 is the first conversion model at the start of training. The result prediction model trained in the previous step S154 is the result prediction model at the start of training. Then, training of the first conversion model, the result prediction model, and the first prediction model is performed in parallel. In the training, the pseudo label given in the previous step S156 is referred to.

In step S256, the information processing device 20A determines whether to end the federated learning. Since a specific example of determining whether to end the federated learning is similar to step S206, detailed description will not be repeated. In a case where it is determined that the learning is not ended, the information processing device 20A repeats the process from step S252.

In the next step S252, the “new global model obtained by integrating the first prediction model and the second prediction model” received from the information processing device 10A becomes the second prediction model at the start of training. The second conversion model trained in the previous step S252 is the second conversion model at the start of training. The intervention prediction model trained in the previous step S252 is the intervention prediction model at the start of training. Then, training of the second conversion model, the intervention prediction model, and the second prediction model is performed in parallel. In the training, the pseudo label given in the previous step S254 is referred to.

In a case where it is determined in step S158 or S256 that the learning is ended, the information processing method S1B ends. As a result, the information processing device 10A can obtain the first prediction model (or the global model) that predicts the effect of the intervention on the subject based on the third feature representing the subject. The information processing device 10A can predict the effect of the intervention on the subject from the first feature representing the subject by using the first conversion model and the first prediction model (or the global model). The information processing device 20A can obtain a second prediction model (or global model) that predicts the effect of intervention on the subject based on the third feature representing the subject. The information processing device 20A can predict the effect of the intervention on the subject from the second feature representing the subject by using the second conversion model and the second prediction model (or the global model).

### Effects of Present Modification

In the present modification, a configuration is adopted in which the first conversion model training unit 15, the result prediction model training unit 14, and the first prediction model training unit 13 train the first conversion model, the result prediction model, and the prediction model in parallel while sharing the output from the first conversion model as inputs of the result prediction model and the prediction model, and the second conversion model training unit 25, the intervention prediction model training unit 24, and the second prediction model training unit 23 train the second conversion model, the intervention prediction model, and the prediction model in parallel while sharing the output from the second conversion model as inputs of the intervention prediction model and the prediction model. As a result, in the information processing device 10A, since the knowledge can be transferred between the task of predicting the effect of the intervention and the task of predicting the result, the performance of the prediction model and the result prediction model can be improved. It is also possible to obtain the effect of obtaining the first conversion model that contributes to improvement of the performance of the prediction model and the result prediction model. In the information processing device 20A, since the knowledge can be transferred between the task of predicting the effect of the intervention and the task of predicting the intervention situation, the performance of the prediction model and the intervention prediction model can be improved. It is also possible to obtain the effect of obtaining the second conversion model that contributes to the improvement of the performance of the prediction model and the intervention prediction model.

### [Other Modifications]

The global model generation unit 19 may be included in the information processing device 20A instead of being included in the information processing device 10A, or may be included in a device different from any of the information processing devices 10A and 20A. Also in the present modification, the information processing system 1A exhibits the above-described effects.

### Application Example

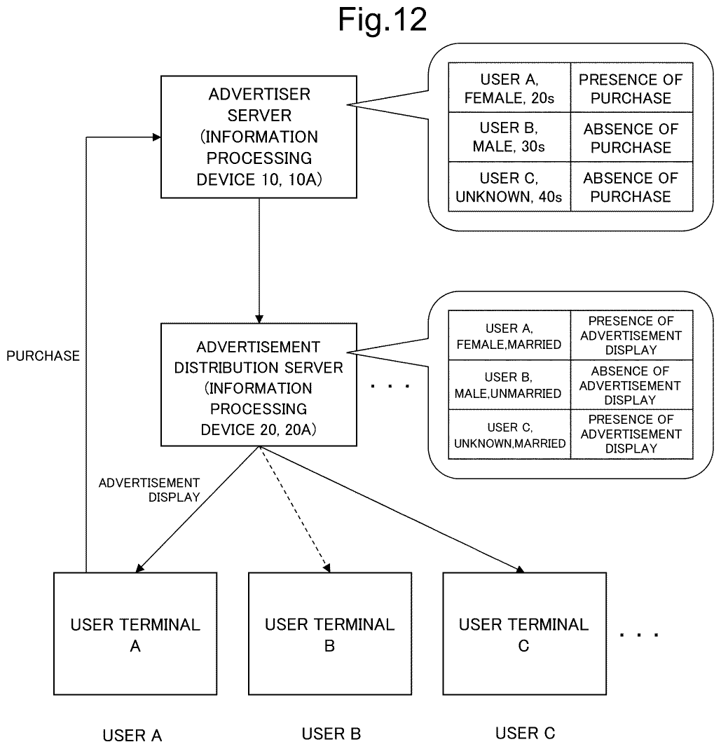

FIG. 12 is a diagram schematically illustrating an application example of predicting a sales promotion effect by advertisement display using the information processing systems 1 and 1A. For example, an advertiser requests one or a plurality of advertisement distribution platforms to distribute an advertisement in order to promote purchase of a product.

In this case, as illustrated in FIG. 12, the advertiser server managed by the advertiser can acquire the gender and age (an example of the first feature) of the user (A, B, C, . . . ) (an example of the subject) and the presence or absence of purchase by the user (an example of the result). The advertisement distribution server managed by the advertisement distribution platform can acquire the gender and the marital status of the user (an example of the second feature), and the presence or absence of advertisement display on the user terminal (A, B, C, . . . ) used by the user (an example of the intervention situation). However, the advertiser server and the advertisement distribution server cannot disclose the presence or absence of purchase by the user and the presence or absence of advertisement display to the user from the viewpoint of privacy protection or the like. For this reason, it is difficult to associate the presence or absence of advertisement display for the user and the presence or absence of purchase by the user. Both the advertiser server and the advertisement distribution server can acquire the “gender” of the user, but only one server can acquire the “age” and the “marital status”. That is, a part of the feature that can be acquired for the user by the advertiser server and the advertisement distribution server is different. Therefore, an advertiser server is applied as an example of the information processing devices 10 and 10A, and an advertisement distribution server is applied as an example of the information processing devices 20 and 20A. As a result, the advertiser server can generate a prediction model that predicts an effect of advertisement display (an example of an effect of intervention) based on the gender and the age of the user. In the advertisement distribution server, the advertiser server can generate a prediction model that predicts an effect of advertisement display (an example of an effect of intervention) based on the gender and the marital status of the user.

According to the present application example, an advertiser may generate a prediction model for predicting a sales promotion effect in cooperation with an advertisement distribution platform. At this time, the advertiser does not need to know whether there is an advertisement display for the user who has purchased the product, does not need to disclose whether the user has purchased the product, and does not need to match the feature of the user to be acquired with the advertisement distribution platform. As a result, the advertiser can predict the sales promotion effect by the advertisement display according to the feature of the user by using the prediction model, and can request the advertisement distribution platform to distribute the advertisement so as to preferentially distribute the advertisement to the user having the highly effective feature.

According to the present application example, the advertisement distribution platform may generate a prediction model for predicting a sales promotion effect in cooperation with an advertiser. At this time, the advertisement distribution platform does not need to know whether the product has been purchased about the user who has displayed the advertisement of the product, does not need to disclose the presence or absence of the advertisement display, and does not need to match the feature of the user to be acquired with the advertiser. As a result, the advertisement distribution platform can predict the sales promotion effect by the advertisement display according to the feature of the user, and can preferentially distribute the advertisement according to the effect. As a result, for example, an increase in an incentive or the like from an advertiser can be expected.

### Example of Implementation by Software

Some or all of the functions of the information processing devices 10, 10A, 20, and 20A (hereinafter, also referred to as “each of the above devices”) constituting the information processing systems 1 and 1A may be implemented by hardware such as an integrated circuit (IC chip) or may be implemented by software.

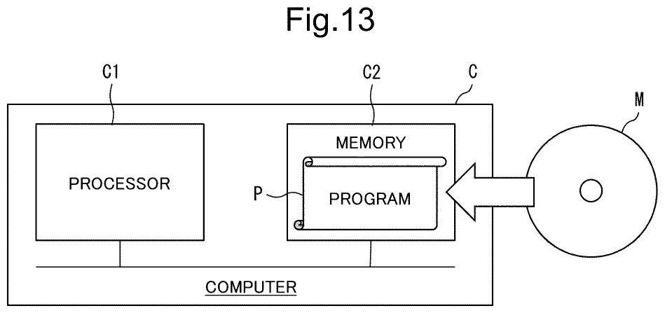

In the latter case, each of the above devices is implemented by, for example, a computer that executes a command of a program which is software for implementing each function. An example of such a computer (hereinafter, referred to as a computer C.) is illustrated in FIG. 13. FIG. 13 is a block diagram illustrating a hardware configuration of a computer C functioning as each of the above devices.

The computer C includes at least one processor C1 and at least one memory C2. A program P causing the computer C to operate as each of the above devices is recorded in the memory C2. In the computer C, the processor C1 reads the program P from the memory C2 and executes the program P to implement each function of each of the above devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

Note that the computer C may further include a random access memory (RAM) for developing the program P at the time of execution and temporarily storing various types of data. In addition, the computer C may further include a communication interface for transmitting and receiving data to and from other devices. The computer C may further include an input/output interface for connecting input/output devices such as a keyboard, a mouse, a display, and a printer.

In addition, the program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. In addition, the program P can be transmitted via a transmission medium. As such a transmission medium, for example, a communication network, a broadcast wave, or the like can be used. The computer C can also acquire the program P via such a transmission medium.

Each of the above functions of each of the above devices may be implemented by one processor provided in one computer, may be implemented in cooperation with a plurality of processors provided in one computer, or may be implemented in cooperation with a plurality of processors provided in a plurality of computers, respectively. The program causing each of the above devices to implement each of the above functions may be stored in one memory provided in one computer, may be stored in a distributed manner in a plurality of memories provided in one computer, or may be stored in a distributed manner in a plurality of memories provided in a plurality of computers, respectively.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

### [Supplementary Note]

The present disclosure includes techniques described in the following supplementary notes. However, the present disclosure is not limited to the techniques described in the following supplementary note, and various modifications can be made within the scope described in the claims.

### (Supplementary Note 1)

An information processing system including:
a first information processing device; and
a second information processing device, wherein
the first information processing device includes:
   one or more memories storing instructions; and
   one or more processors configured to execute the instructions to:
   acquire a first feature representing a subject and a result obtained for the subject;
   predict an intervention situation that could have affected the result based on the first feature; and
   train a prediction model that predicts an effect of the intervention using federated learning performed by the first information processing device and the second information processing device based on a third feature converted from the first feature, the result, and the intervention situation,
the second information processing device includes:
   one or more memories storing instructions; and
   one or more processors configured to execute the instructions to:
   acquire a second feature representing a subject and the intervention situation;
   predict the result based on the second feature; and
   train the prediction model by the federated learning based on the third feature converted from the second feature, the result, and the intervention situation, and
the third feature is a feature converted from the first feature and the second feature in such a way that feature distributions are similar in a same feature space.

### (Supplementary Note 2)

The information processing system according to Supplementary Note 1, wherein
the one or more processors of the first information processing device are further configured to execute the instructions to:
   train a first conversion model that converts the first feature into the third feature;
   train a result prediction model for predicting the result from the third feature; and
   predict the intervention situation using the first conversion model and an intervention prediction model that predicts the intervention situation from the third feature, and
the one or more processors of the second information processing device are further configured to execute the instructions to:
   train a second conversion model that converts the second feature into the third feature;
   train the intervention prediction model; and
   predict the result using the second conversion model and the result prediction model.

### (Supplementary Note 3)

The information processing system according to Supplementary Note 2, wherein
the one or more processors of the first information processing device and the one or more processors of the second information processing device exchange statistical information of the third feature, and train the first conversion model and the second conversion model, respectively, so as to reduce a difference by including a term relevant to the difference between the statistical information in a loss function.

### (Supplementary Note 4)

The information processing system according to Supplementary Note 2, wherein
the one or more processors of the first information processing device and the one or more processors of the second information processing device cooperatively train an identification model that identifies from which of the first feature and the second feature the third feature has been converted, and train the first conversion model and the second conversion model so as to output a third feature that causes the identification model to perform erroneous identification.

### (Supplementary Note 5)

The information processing system according to Supplementary Note 2, wherein
training of the first conversion model, training of the result prediction model, and training of the prediction model are performed independently of each other, and
training of the second conversion model, training of the intervention prediction model, and training of the prediction model are performed independently of each other.

### (Supplementary Note 6)

The information processing system according to Supplementary Note 2, wherein
the one or more processors of the first information processing device train the first conversion model, the result prediction model, and the prediction model in parallel while sharing an output from the first conversion model as inputs of the result prediction model and the prediction model, and
the one or more processors of the second information processing device train the second conversion model, the intervention prediction model, and the prediction model in parallel while sharing an output from the second conversion model as inputs of the intervention prediction model and the prediction model.

### (Supplementary Note 7)

An information processing device including:
one or more memories storing instructions; and
one or more processors configured to execute the instructions to:
acquire a feature representing a subject and a result obtained for the subject;
predict an intervention situation that could have affected the result based on the feature; and
train a prediction model that predicts an effect of the intervention using federated learning performed by another information processing device capable of acquiring the intervention situation and the information processing device based on a converted feature converted from the feature, the result, and the intervention situation,
wherein the converted feature is a feature converted from the feature and another feature acquired for the subject by the another information processing device in such a way that feature distributions are similar in a same feature space.

### (Supplementary Note 8)

An information processing device including:
one or more memories storing instructions; and
one or more processors configured to execute the instructions to:
acquire a feature representing a subject and an intervention situation that could have affected a result obtained for the subject;
predict the result based on the feature; and
train a prediction model that predicts an effect of the intervention using federated learning performed by another information processing device capable of acquiring the result and the information processing device based on a converted feature converted from the feature, the result, and the intervention situation,
wherein the converted feature is a feature converted from the feature and another feature acquired for the subject by the another information processing device in such a way that feature distributions are similar in a same feature space.

### (Supplementary Note 9)

An information processing method executed by an information processing system including a first information processing device and a second information processing device, the method including:
acquiring, by at least one processor included in the first information processing device, a first feature representing a subject and a result obtained for the subject;
predicting, by at least one processor included in the first information processing device, an intervention situation that could have affected the result based on the first feature;
training, by at least one processor included in the first information processing device, a prediction model that predicts an effect of the intervention using federated learning performed by the first information processing device and the second information processing device based on a third feature converted from the first feature, the result, and the intervention situation;
acquiring, by at least one processor included in the second information processing device, a second feature representing a subject and the intervention situation;
predicting, by at least one processor included in the second information processing device, the result based on the second feature; and
training, by at least one processor included in the second information processing device, the prediction model by the federated learning based on the third feature converted from the second feature, the result, and the intervention situation,
wherein the third feature is a feature converted from the first feature and the second feature in such a way that feature distributions are similar in a same feature space.

### (Supplementary Note 10)

An information processing method executed by a computer including:
acquiring, by at least one processor included in an information processing device, a feature representing a subject and a result obtained for the subject;
predicting, by the at least one processor, an intervention situation that could have affected the result based on the feature; and
training, by the at least one processor, a prediction model that predicts an effect of the intervention using federated learning performed by another information processing device capable of acquiring the intervention situation and the information processing device based on a converted feature converted from the feature, the result, and the intervention situation,
wherein the converted feature is a feature converted from the feature and another feature acquired for the subject by the another information processing device in such a way that feature distributions are similar in a same feature space.

### (Supplementary Note 11)

An information processing method executed by a computer including:
acquiring, by at least one processor included in an information processing device, a feature representing a subject and an intervention situation that could have affected a result obtained for the subject;
predicting, by the at least one processor, the result based on the feature; and
training, by the at least one processor, a prediction model that predicts an effect of the intervention using federated learning by another information processing device capable of acquiring the result and the own device based on a converted feature converted from the feature, the result, and the intervention situation,
wherein the converted feature is a feature converted from the feature and another feature acquired for the subject by the another information processing device in such a way that feature distributions are similar in a same feature space.

### (Supplementary Note 12)

An information processing program causing at least one processor included in the information processing device according to Supplementary Note 7 to execute acquisition, prediction, and prediction model training.

### (Supplementary Note 13)

An information processing program causing at least one processor included in the information processing device according to Supplementary Note 8 to execute acquisition, prediction, and prediction model training.

The first information processing device may further include a memory. The memory may store a program for causing the at least one processor included in the first information processing device to execute each of the processes. The second information processing device may further include a memory. The memory may store a program for causing the at least one processor included in the second information processing device to execute each of the processes.

1. An information processing system comprising:
a first information processing device; and
a second information processing device, wherein
the first information processing device includes:
one or more memories storing instructions; and
one or more processors configured to execute the instructions to:
acquire a first feature representing a subject and a result obtained for the subject;
predict an intervention situation that could have affected the result based on the first feature; and
train a prediction model that predicts an effect of the intervention using federated learning performed by the first information processing device and the second information processing device based on a third feature converted from the first feature, the result, and the intervention situation,
the second information processing device includes:
one or more memories storing instructions; and
one or more processors configured to execute the instructions to:
acquire a second feature representing a subject and the intervention situation;
predict the result based on the second feature; and
train the prediction model by the federated learning based on the third feature converted from the second feature, the result, and the intervention situation, and
the third feature is a feature converted from the first feature and the second feature in such a way that feature distributions are similar in a same feature space.

2. The information processing system according to claim 1, wherein
the one or more processors of the first information processing device are further configured to execute the instructions to:
train a first conversion model that converts the first feature into the third feature;
train a result prediction model for predicting the result from the third feature; and
predict the intervention situation using the first conversion model and an intervention prediction model that predicts the intervention situation from the third feature, and
the one or more processors of the second information processing device are further configured to execute the instructions to:
train a second conversion model that converts the second feature into the third feature;
train the intervention prediction model; and
predict the result using the second conversion model and the result prediction model.

3. The information processing system according to claim 2, wherein
the one or more processors of the first information processing device and the one or more processors of the second information processing device exchange statistical information of the third feature, and train the first conversion model and the second conversion model, respectively, so as to reduce a difference by including a term relevant to the difference between the statistical information in a loss function.

4. The information processing system according to claim 2, wherein
the one or more processors of the first information processing device and the one or more processors of the second information processing device cooperatively train an identification model that identifies from which of the first feature and the second feature the third feature has been converted, and train the first conversion model and the second conversion model so as to output a third feature that causes the identification model to perform erroneous identification.

5. The information processing system according to claim 2, wherein
training of the first conversion model, training of the result prediction model, and training of the prediction model are performed independently of each other, and
training of the second conversion model, training of the intervention prediction model, and training of the prediction model are performed independently of each other.

6. The information processing system according to claim 2, wherein
the one or more processors of the first information processing device train the first conversion model, the result prediction model, and the prediction model in parallel while sharing an output from the first conversion model as inputs of the result prediction model and the prediction model, and
the one or more processors of the second information processing device train the second conversion model, the intervention prediction model, and the prediction model in parallel while sharing an output from the second conversion model as inputs of the intervention prediction model and the prediction model.

7. An information processing device comprising:
one or more memories storing instructions; and
one or more processors configured to execute the instructions to:
acquire a feature representing a subject and a result obtained for the subject;
predict an intervention situation that could have affected the result based on the feature; and
train a prediction model that predicts an effect of the intervention using federated learning performed by another information processing device capable of acquiring the intervention situation and the information processing device based on a converted feature converted from the feature, the result, and the intervention situation,
wherein the converted feature is a feature converted from the feature and another feature acquired for the subject by the another information processing device in such a way that feature distributions are similar in a same feature space.

8. An information processing method executed by a computer comprising:
acquiring, by at least one processor included in the first information processing device, a first feature representing a subject and a result obtained for the subject;
predicting, by at least one processor included in the first information processing device, an intervention situation that could have affected the result based on the first feature;
training, by at least one processor included in the first information processing device, a prediction model that predicts an effect of the intervention using federated learning performed by the first information processing device and the second information processing device based on a third feature converted from the first feature, the result, and the intervention situation;
acquiring, by at least one processor included in the second information processing device, a second feature representing a subject and the intervention situation;
predicting, by at least one processor included in the second information processing device, the result based on the second feature; and
training, by at least one processor included in the second information processing device, the prediction model by the federated learning based on the third feature converted from the second feature, the result, and the intervention situation,
wherein the third feature is a feature converted from the first feature and the second feature in such a way that feature distributions are similar in a same feature space.
